(19) United States
(12) Patent Application Publication
(10) Pub. No.: US 2004/0106452 A1
(43) Pub. Date: Jun. 3, 2004

(54) Hosted game development environment

(75) Inventors: Binh T. Nguyen, Reno, NV (US); Joseph R. Hedrick, Reno, NV (US)

Correspondence Address: BEYER WEAVER & THOMAS LLP, P.O. BOX 778, BERKELEY, CA, 94704-0778, US

(73) Assignee: IGT

(21) Appl. No.: 10/308,845

(22) Filed: Dec. 2, 2002

(51) Int. Cl. G06F 17/00

(52) U.S. Cl. 463/42

(57) ABSTRACT

Methods and apparatus are described for developing a computer program corresponding to a game of chance over a wide area network. Access by a game developer to a plurality of software tools is provided via the wide area network. The software tools are operable by the game developer to develop the computer program. Access by the game developer to a library of software objects is also provided via the wide area network. The software objects are for associating with the computer program to enable operation of the game of chance. The software objects include pay tables. The computer program is operable to enable playing of the game of chance.

### BACKGROUND OF THE INVENTION

The present invention relates to the gaming industry, and more specifically to methods and apparatus for developing games of chance for use in the gaming industry.

New games of chance for computerized gaming machines are constantly being developed to keep up with continued strong demand from the gaming public. The main providers of gaming machines typically employ large staffs of game developers, yet still find it challenging to keep up with this demand. The market for new games of chance is also served by small companies and individual game developers. However, because of the complex regulatory schemes in the gaming industry, and the diversity of such schemes across gaming jurisdictions, the barriers to entry and regulatory acceptance of games developed by such entities, and particularly individuals, are often prohibitively high. As a result, the available game development bandwidth is not being applied to meet the existing demand.

Because of the regulatory barriers mentioned above, individual developers often approach the larger providers of gaming machines with their ideas for new games of chance in the hope that these large providers will use their established infrastructure to develop and promote gaming machines based on their ideas. While this may appear to be a fertile avenue for tapping unused game development bandwidth, it is, in reality, fraught with administrative and even legal difficulties for the gaming machine providers which make such an approach undesirable.

It is therefore desirable to provide techniques by which the available game development creativity, expertise, and bandwidth may be more efficiently utilized to meet the ever-increasing demand for new games of chance.

### SUMMARY OF THE INVENTION

According to the present invention, a hosted game development environment is provided which facilitates creation and testing of new games of chance. According to specific embodiments, the established infrastructure of the host of the game development environment is employed to facilitate regulatory approval and distribution of the new games of chance developed in the hosted environment.

Thus, the invention provides methods and apparatus for developing a computer program corresponding to a game of chance over a wide area network. Access by a game developer to a plurality of software tools is provided via the wide area network. The software tools are operable by the game developer to develop the computer program. The software tools also operable to design custom objects for associating with the computer program to enable operation of the game of chance. The custom objects include custom pay tables. Access by the game developer to a library of software objects is also provided via the wide area network. The software objects are for associating with the computer program to enable operation of the game of chance. The software objects include library pay tables. The computer program is operable to enable playing of the game of chance.

According to various embodiments, the objects provided may also comprise clip art, audio clips, video clips, textures, reel symbols, fonts, edit tools, simulation tools, game templates, scripting languages, and bonus games. In addition, according to such embodiments, the capability of creating custom versions of such objects is also provided.

According to some embodiments, methods for facilitating development and regulatory acceptance of games of chance are provided. Access by a plurality of game developers to a game development environment in which the game developers may develop computer programs in a first format is provided. The computer programs correspond to the games of chance. The first format is sufficient for enabling playing of the games of chance. The computer programs are converted from the first format to a second format, the second format being acceptable for operation in a regulated gaming system. The computer programs are submitted in the second format to at least one regulatory agency for approval.

A further understanding of the nature and advantages of the present invention may be realized by reference to the remaining portions of the specification and the drawings.

### BRIEF DESCRIPTION OF THE DRAWINGS

FIG. 1 is a simplified diagram of a network environment in which a particular embodiment of the invention may be practiced. FIG. 1 also illustrates relationships among a gaming machine provider, and the gaming control boards and gaming establishments in a plurality of gaming jurisdictions.

FIG. 2 is a flowchart illustrating a specific embodiment of the present invention.

FIG. 3 is a gaming machine which may be used in accordance with a particular embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known process operations have not been described in detail in order not to unnecessarily obscure the present invention.

Embodiments of the present invention incorporate aspects of the Application Service Provider (ASP) paradigm to provide a game development environment by which individual game developers may interface with a larger manufacturer in the gaming industry market, and in which such developers may employ a variety of software tools and existing libraries of content to convert their ideas for new games of chance into reality. Further embodiments of the invention are also provided by which games developed according to such a model may be demonstrated, tested, converted to an appropriate platform, guided through the relevant regulatory process(es), and distributed.

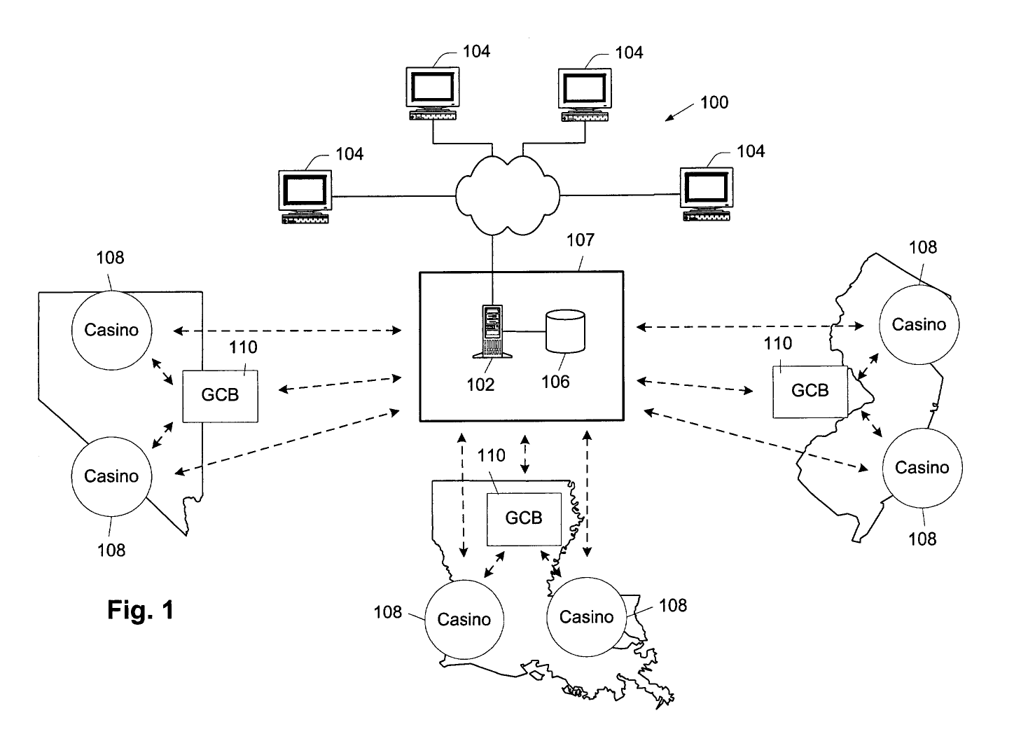

FIG. 1 shows an exemplary network environment 100 in which various embodiments of the invention may be practiced. Although the subsequent description assumes that this network is a wide area network employing the TCP/IP protocol (e.g., the Internet or the World Wide Web), it will be understood that the network shown is merely exemplary and should not be thought of as limiting the scope of the invention in any way. Rather, the various embodiments of the invention described herein may be implemented in any of a wide variety of network environments and topologies and using any of a wide variety of network devices and network communication and data transmission protocols.

In the embodiment shown, game development server 102 is maintained and operated by a gaming machine provider such as, for example, International Game Technology (IGT) of Reno, Nev., and may represent one or more servers in one or more locations. Server 102 may also be implemented using any of a wide variety of commercially available servers. It will be understood that a wide variety of entities may play this role according to alternative embodiments of the invention. Server 102 hosts a game development environment implemented in accordance with the present invention. Network 100 facilitates access by game developer clients 104 to the development environment on server 102. According to various specific embodiments, clients 104 comprise personal computers, workstations, or any other type of personal computing devices.

According to a specific embodiment, clients 104 employ a local client to interact with server 102 via network 100. According to one embodiment, this interaction is made secure using some form of encryption, e.g., the well known RSA technologies. The graphical user interfaces hosted by server 102 provide the game developers at clients 104 access to a web-based Game Developer's Kit (GDK) which comprises a plurality of software tools and objects. According to various embodiments, the GDK may comprise any of a wide variety of proprietary and/or publicly available object-oriented software (e.g., Java) authoring tools which are capable of constructing interactive games. Such tools may include for example, compilers, optimizers, debuggers, sequencers, scripting languages (e.g., to control game flow), animation tools, graphics engines, etc.

According to some embodiments, the software tools include a graphics engine which allows the game developer to customize the visual aspects of the game by, for example, allowing him to create visual representations of a world or universe associated with the game. A graphics engine is low-level software that interacts with the hardware to display a scene. For example, in response to the scripting command “spin reels,” the underlying graphics engine would begin the animation sequence by computing the pixels to display, and then request that the graphics card display the animation on the screen. A typical graphics engine might facilitate animation, texture, lighting, rendering, zooming, panning, clipping, or any combination thereof.

The GDK may also comprise one or more libraries of preexisting software objects (e.g., library 106) which may be employed in the construction of such games. Examples of such software objects include, but are not limited to, game templates (e.g., poker, blackjack, spinning reels, keno, etc.), bonus templates, clip art, graphics, audio clips, video clips, paytables, and any combination thereof. Game templates might include pay tables, graphics symbols (e.g., reels and cards), game layout defaults (e.g., buttons, reels, and credit meters), and fonts.

The developer may also contribute his own objects which may ultimately become part of library 106. Additional game customization tools may also be provided to enable the game developer to develop a unique look and feel for his new games. According to various embodiments, the GDK's user interface may be graphical, scripting based, template based (e.g., fill-in-the-blank variety), or any combination of these.

According to embodiments in which the game development site corresponding to server 102 is hosted by a gaming machine provider 107 such as IGT, the gaming machine provider's experience with the regulatory process, and its manufacturing and distribution infrastructure are represented by the dashed lines indicating the existing relationships with or experience dealing with the corresponding entities, e.g., gaming establishments 108 and gaming control boards (GCBs) 110. That is, the dashed lines between gaming machine provider 107 and gaming establishments 108 may represent, for example, the distribution chain by which gaming machines are provided to the gaming establishments, as well as the ongoing service relationship between the two entities. By contrast, the dashed lines between the gaming machine provider and GCBs 110 may represent the regulatory approval process for new games, as well as the ongoing oversight provided by the GCBs of the distribution of gaming machines in their corresponding jurisdictions. The dashed lines between gaming establishments 108 and GCBs 110 represent the interactions between these entities.

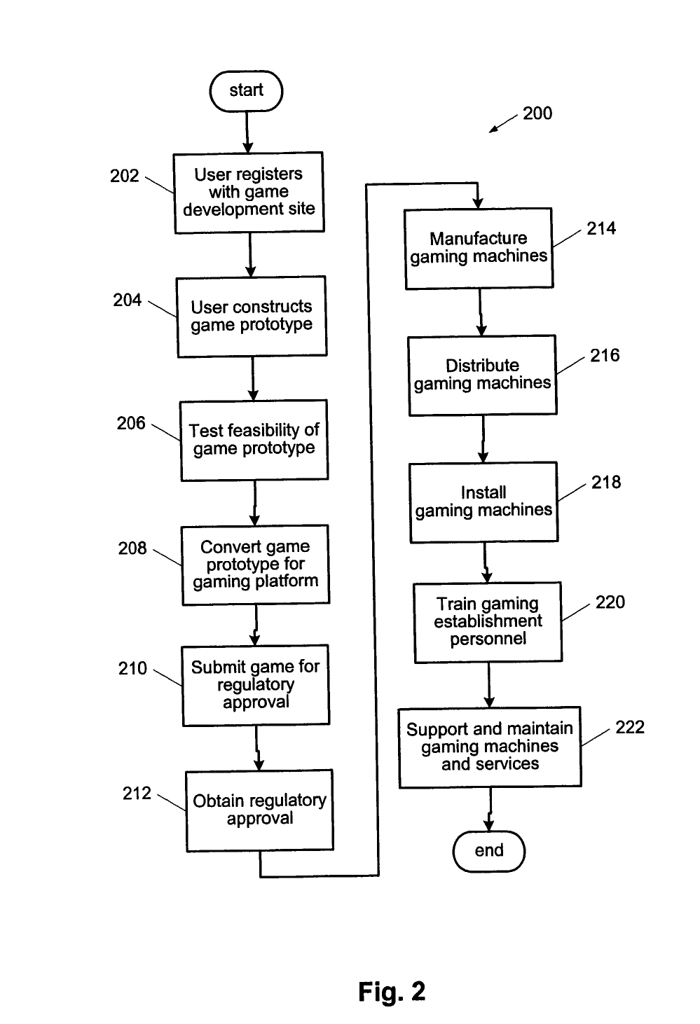

Referring to flowchart 200 of FIG. 2, a game developer registers with a game development site designed in accordance with the present invention via the World Wide Web (202). As part of this registration process a contractual relationship between the parties may be established which may include, for example, financial terms regarding the development and/or exploitation of any games developed on the site. For example, the game developer might pay for actual usage of the GDK (e.g., dollars per unit time), or a subscription fee for unlimited use (e.g., a monthly fee). Alternatively or additionally, the site host and the game developer might contract for ownership and control of games developed on the site, and/or a percentage of any revenues derived from distribution and/or use of gaming machines based on games developed on the site.

The game developer may then use the GDK, any of a variety of existing game templates and library objects, and any additional objects contributed by the game developer himself to construct a game prototype which is actually operable to play the intended game (204). As will be understood, the game developer does not necessarily need to avail himself of available game templates or objects to generate the prototype. The prototype may be in a neutral or proprietary format. This format could be subsequently recompiled to a specific target, e.g., hardware specific slot machines.

The game developer (or alternatively the site host) may then test the feasibility of the prototype using game qualification services provided by the site host (206). These services may include, for example, paytable testing (for custom created tables), feasibility testing, regulatory compliance testing, market acceptance testing (e.g., field trials), etc. The site may also automatically generate any necessary documentation of the game development process which may be required for any subsequent regulatory approval process. The ability to document and to make the game development process secure benefits both the game developers and the host of the game development site by eliminating much of the uncertainty and risk by which such relationships are traditionally characterized.

According to a specific embodiment and as mentioned above, the game development site may be hosted by a gaming machine manufacturer such as IGT. According to such an embodiment, the existing infrastructure of such an entity may be employed to facilitate regulatory approval and distribution of games of chance developed on the game development site.

Referring back to FIG. 2, a gaming machine manufacturer has the capability of taking the game prototype tested in 206 and converting it to a format amenable for use on a gaming machine platform in a gaming establishment, e.g., a casino (208). Alternatively, the format might be for use on an Internet gaming platform. As will be understood, the appropriate final format will vary depending on the environment in which the game is intended to be deployed. In any case, the format to which the game is converted will typically have the characteristics required for operation within the gaming industry. That is, for regulatory approval as well as customer satisfaction, games in the gaming industry must be robust and secure. For example, player balances on a given machine must be maintained in the face of power glitches and potential security breaches. Prototypes developed according to the present invention will not typically have such characteristics in that it is not economically reasonable to build such features into the software until the feasibility of the game has been tested.

In addition, because of the complexity of the regulatory approval process and the diversity of gaming jurisdictions, and the cost associated with obtaining such approval, submission of the game to one or more Gaming Control Boards (GCBs) in such gaming jurisdictions (210) may be more easily facilitated by the gaming machine manufacturer than would be possible by the game developer acting alone due to the manufacturer's dedicated infrastructure and experience with the process.

Once regulatory approval in the relevant jurisdictions is obtained (212), the manufacturer's infrastructure and relationships with gaming establishments may be leveraged to manufacture gaming machines based on the new game (214), distribute the gaming machines to gaming establishments (216), install the gaming machines (218), train the gaming establishment personnel in the use of the gaming machines (220), and provide maintenance and support (as well as a variety of other services) for the hardware and software of the gaming machines (222).

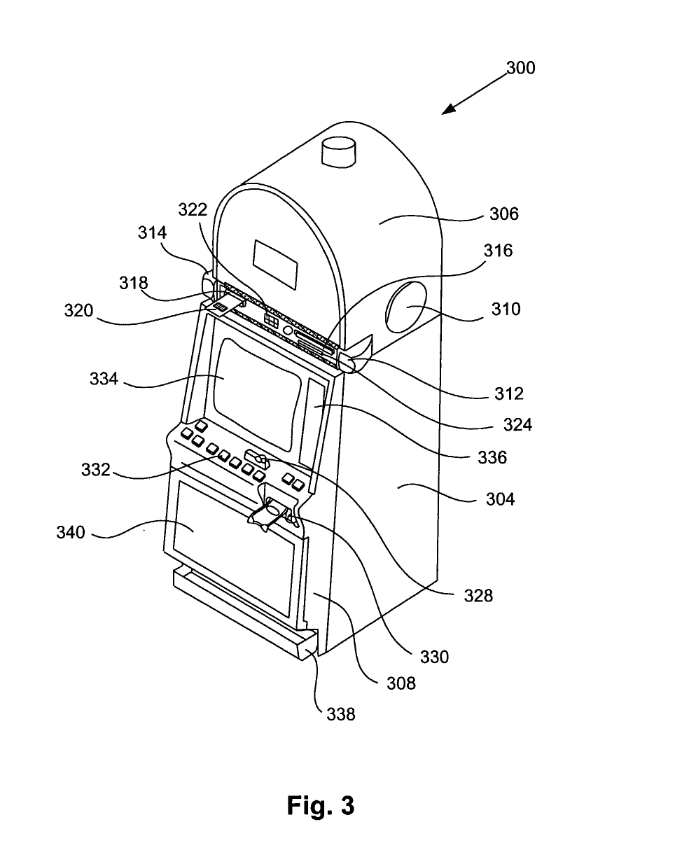

FIG. 3 is a block diagram of an exemplary video gaming machine 300 for enabling operation of the games of chance developed according to various embodiments of the present invention. Machine 300 includes a main cabinet 304, which generally surrounds the machine interior (not shown) and is viewable by users. The main cabinet includes a main door 308 on the front of the machine, which opens to provide access to the interior of the machine. Attached to the main door are player-input switches or buttons 332, a coin acceptor 328, and a bill validator 330, a coin tray 338, and a belly glass 340. Viewable through the main door is a video display monitor 334 and an information panel 336. The display monitor 334 will typically be a cathode ray tube, high resolution flat-panel LCD, or other conventional electronically controlled video monitor. The information panel 336 may be a back-lit, silk screened glass panel with lettering to indicate general game information including, for example, the number of coins played. The bill validator 330, player-input switches 332, video display monitor 334, and information panel are devices used to play a game on the game machine 300.

The various device and functionalities of gaming machine 300 devices are controlled by circuitry (not shown) housed inside the main cabinet 304. According to some embodiments, the control circuitry of gaming machine 300 comprises a conventional personal computer, workstation, or similar device which facilitates the functionality of the individual gaming machine 300 as well as provides an interface (not shown) to a gaming network (e.g., gaming network 100 of FIG. 1) using proprietary or conventional protocols such as, for example, Ethernet, TCP/IP, etc. Using such an interface, information relating to game activity on gaming machine 300 may be transmitted over the gaming network for any of a variety of purposes including, for example, effecting control or triggering payment of a progressive jackpot.

The gaming machine 300 includes a top box 306, which sits on top of the main cabinet 304. The top box 306 houses a number of devices, which may be used to add features to a game being played on the gaming machine 300, including speakers 310, 312, 314, a ticket printer 318 which may print bar-coded tickets 320, a key pad 322 for entering player tracking information, a florescent display 316 for displaying player tracking information, a card reader 324 for entering a magnetic striped card containing player tracking information. Further, the top box 306 may house different or additional devices than shown in FIG. 3. For example, the top box may contain a bonus wheel or a back-lit silk screened panel which may be used to add bonus features to the game being played on the gaming machine. During a game, these devices are controlled and powered, in part, by circuitry (not shown) housed within the main cabinet 304 of the machine 300.

In addition to facilitating regulatory approval and distribution of new games of chance, the expertise and infrastructure of the gaming machine manufacturer may also be leveraged to facilitate any of a variety of additional gaming services in conjunction with the playing of the new game. This would enable a level of excitement and interest for the game player that might not otherwise have been possible in the unlikely event that the independent game developer himself had actually been successful in obtaining regulatory approval and distribution of his game. For example, in networked gaming environments in which multiple games are linked, progressive jackpot services may be enabled. Player tracking services in which, for example, players are rewarded for their patronage of particular gaming establishments, may also be enabled.

While the invention has been particularly shown and described with reference to specific embodiments thereof, it will be understood by those skilled in the art that changes in the form and details of the disclosed embodiments may be made without departing from the spirit or scope of the invention. For example, embodiments have been described in which game developer may employ preexisting game templates to construct new games. However, it will be understood that embodiments in which such games are developed without such templates are within the scope of the invention. In addition, the host of a game development environment implemented according to the present invention does not necessarily need to be a gaming machine provider or manufacturer to remain within the scope of the invention. And as discussed above, any of a wide range of technologies may be employed to implement and provide access to such a game development environment.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for developing a computer program corresponding to a game of chance over a wide area network, comprising:
providing access by a game developer to a plurality of software tools via the wide area network, the software tools being operable by the game developer to develop the computer program, the software tools also being operable to design custom objects for associating with the computer program to enable operation of the game of chance, the custom objects including custom pay tables; and
providing access by the game developer to a library of software objects via the wide area network, the software objects being for associating with the computer program to enable operation of the game of chance, the software objects including library pay tables;
wherein the computer program is operable to enable playing of the game of chance.

2. The method of claim 1 wherein providing access to the plurality of software tools and the library of software objects comprises providing at least one graphical user interface, the graphical user interface being any of graphical, script based, template based, and any combination thereof.

3. The method of claim 1 wherein providing access to the plurality of software tools comprises providing access to at least one object oriented software authoring tool.

4. The method of claim 3 wherein the at least one object oriented software authoring tool comprises any of a compiler, an optimizer, a debugger, a sequencer, a scripting language, an animation tool, and a graphics engine.

5. The method of claim 1 wherein the library of software objects further includes any of clip art, audio clips, video clips, textures, reel symbols, fonts, edit tools, simulation tools, game templates, scripting languages, and bonus games.

6. The method of claim 1 wherein the software objects further include at least one game template.

7. The method of claim 6 wherein the at least one game template comprises at least one pay table, graphics symbols representing at least one of reels and cards, game layout defaults, and fonts.

8. The method of claim 7 wherein the game layout defaults include buttons, reels, and credit meters.

9. The method of claim 1 wherein the software tools comprise at least one graphics engine.

10. The method of claim 9 wherein the at least one graphics engine comprises components relating to any of animation, texture, lighting, rendering, zooming, panning, and clipping.

11. The method of claim 1 further comprising providing game qualification services via the wide area network for qualifying the computer program.

12. The method of claim 1 further comprising converting the computer program to at least one format suitable for submission to at least one gaming regulatory agency.

13. The method of claim 12 wherein each format is determined, at least in part, with reference to requirements established by a corresponding one of the at least one gaming regulatory agency.

14. The method of claim 12 further comprising submitting the computer program to the at least one gaming regulatory agency for approval.

15. The method of claim 12 wherein the at least one gaming regulatory agency comprises a plurality of gaming regulatory agencies.

16. The method of claim 12 further comprising obtaining regulatory approval of the computer program from the at least one gaming regulatory agency.

17. The method of claim 1 further comprising distributing the computer program to any of gaming establishments, home computers, televisions, and handheld devices.

18. The method of claim 17 wherein distributing the computer programs may comprises either of physical or electronic distribution.

19. The method of claim 17 wherein the computer program is distributed to gaming establishments, the method further comprising providing at least one added service relating to operation of the computer program in the gaming establishments.

20. The method of claim 19 wherein the at least one added service comprises any of progressive jackpot services, player tracking services, gaming establishment employee training services, software support services, and hardware support services.

21. At least one computer data signal embodied in a carrier wave and representing computer program instructions for implementing the method of claim 1.

22. A gaming machine comprising a computer-readable medium having the computer program of claim 1 stored therein, the gaming machine further comprising a central processing unit operable to facilitate operation of the computer program, and an interface by which a game player may interact with the gaming machine to play the game of chance.

23. A method for facilitating development and regulatory acceptance of games of chance, comprising:
providing access by a plurality of game developers to a game development environment in which the game developers may develop computer programs in a first format, the computer programs corresponding to the games of chance, the first format being sufficient for enabling playing of the games of chance;
converting the computer programs from the first format to a second format, the second format being acceptable for operation in a regulated gaming system; and
submitting the computer programs in the second format to at least one regulatory agency for approval.

24. The method of claim 23 wherein the second format is determined, at least in part, with reference to requirements established by the at least one regulatory agency.

25. The method of claim 23 wherein the at least one regulatory agency comprises a plurality of regulatory agencies.

26. The method of claim 23 further comprising obtaining regulatory approval of the computer programs from the at least one regulatory agency.

27. The method of claim 23 further comprising distributing the computer programs to any of gaming establishments, home computers, televisions, and handheld devices.

28. The method of claim 27 wherein the computer programs are distributed to gaming establishments, the method further comprising providing at least one added service relating to operation of the computer programs in the gaming establishments.

29. The method of claim 28 wherein the at least one added service comprises any of progressive jackpot services, player tracking services, gaming establishment employee training services, software support services, and hardware support services.
